(19) United States
(12) Patent Application Publication
(10) Pub. No.: US 2026/0339379 A1
(43) Pub. Date: Oct. 29, 2026

(54) MULTI-DIRECTION INPUT DEVICE, CONTROL HANDLE HAVING THE DEVICE, AND CONTROL APPARATUS HAVING THE CONTROL HANDLE

(71) Applicant: SHENZHEN ZESUM TECHNOLOGY CO., LTD, Shenzhen (CN)

(72) Inventors: XIAN-WU HU, Shenzhen (CN); CHAO-XIAN CHEN, Shenzhen (CN)

(21) Appl. No.: 19/387,946

(22) Filed: Nov. 13, 2025

(30) Foreign Application Priority Data
Feb. 25, 2025 (CN) 202510222273.9

(51) Int. Cl. G05G 9/047

(52) U.S. Cl. CPC G05G 9/04788; G05G 2009/04703; G05G 2009/04744

(57) ABSTRACT

A multi-direction input device includes a housing, an operation member, a swinging assembly, a circuit board, and an electrical connection assembly. The housing defines a cavity and an opening. The operation member is partially housed in the cavity and is swingable relative to the housing and includes an operation body with a first end that extends out through the opening. The swinging assembly is rotatably connected to the housing and linked to the operation member. It has first and second swinging arms pivoting on perpendicular axes. At least one swinging arm includes a swinging body, two pivot portions at its ends, and a drive portion located in the cavity. The circuit board is housed within the cavity. The electrical connection assembly is connected to both the circuit board and the drive portion. The circuitry on the board is configured to sense positional changes of the electrical connection assembly.

### CROSS-REFERENCE TO RELATED APPLICATIONS

The present application claims the benefit and priority to Chinese Patent Application Serial No. 202510222273.9, filed on Feb. 25, 2025, in China National Intellectual Property Administration, and the content of which is hereby fully incorporated by reference into the present application.

### FIELD

The subject matter relates to input devices, and particularly to a multi-direction input device, a control handle having the input device, and a control apparatus having the control handle.

### BACKGROUND

Multi-direction input devices are used in game control handles, unmanned aerial vehicles, compact cameras, and stabilizers. An existing multi-direction input device may have a large size and a complex structure with many components, which hinder the application of the multi-direction input device in a miniaturized portable product.

### BRIEF DESCRIPTION OF THE DRAWINGS

Implementations of the present technology will now be described, by way of example only, with reference to the attached figures, wherein:

FIG. 1 is a schematic view of a multi-direction input device according to an embodiment of the present application.

FIG. 2 is an exploded view of the device shown in FIG. 1.

FIG. 3 is a sectional view taken along line IV–IV in FIG. 1.

FIG. 4 is a schematic view of the multi-direction input device show in FIG. 1, a housing is removed from the multi-direction input device.

FIG. 5 is a schematic view showing an operation member of the multi-direction input shown in FIG. 4, the operation member is swung toward a first direction.

FIG. 6 is a schematic view of a control handle including the input device shown in FIG. 1.

FIG. 7 is a schematic view of a control apparatus including the control handle shown in FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

For clarity, terms such as “first,” “second,” etc. are used for distinction and do not limit the scope. Unless otherwise stated, a first direction X, a second direction Y, and a third direction Z may be mutually perpendicular. The drawings are schematic and not necessarily to scale.

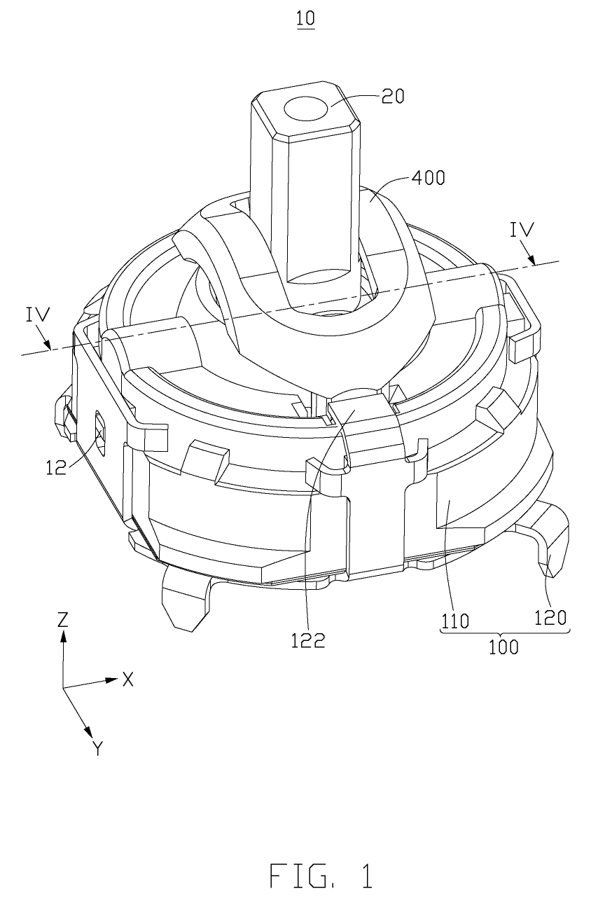

Referring to FIGS. 1, 2 and 3, a multi-direction input device 10 is provided according to an embodiment of the present application. The device 10 includes a housing 100, an operation member 20, a swinging assembly 400, a circuit board 300, and an electrical connection assembly 500. The housing 100 defines an opening 103 and a cavity 104 communicates with the opening 103. The operation member 20 is swingable under an external force. At least a portion of the operation member 20 is received in the cavity 104. The operation member 20 includes an operation body 200. The operation body 200 includes a first end 201. The first end 201 extends out of the cavity 104 through the opening 103. The swinging assembly 400 is at least partially disposed in the housing 100. The swinging assembly 400 is rotatably mounted to the housing 100. The operation member 20 is connected to the swinging assembly 400. The swinging assembly 400 includes a first swinging arm 401 and a second swinging arm 402. The first swinging arm 401 rotates about a second direction Y. The second swinging arm 402 rotates about a first direction X perpendicular to the second direction Y. At least one of the first swinging arm 401 and the second swinging arm 402 includes a swinging body 410, two pivot portions 411, and a drive portion 412. The two pivot portions 411 are arranged at two opposite ends of the swinging body 410. The drive portion 412 is arranged on one of the two pivot portions 411. The drive portion 412 is disposed in the cavity 104. The circuit board 300 is arranged in the cavity 104. The electrical connection assembly 500 is mounted on and electrically connected to the circuit board 300. The drive portion 412 is drivingly coupled to the electrical connection assembly 500. The electrical connection assembly 500 moves with the drive portion 412. The circuit board 300 senses a position change of the electrical connection assembly 500.

In other embodiments, the first swinging arm 401 rotates about a direction except for the second direction Y. The second swinging arm 402 rotates about a direction except for the first direction X. The two directions about which the first swinging ram 401 and the second swinging arm rotate are perpendicular to each other.

This design optimizes the electrical connection assembly 500 and the swinging arm assembly 400 by integrating the electrical connection assembly 500 inside the cavity 104 of the housing 100. Compared to an existing multi-direction input device which places the electrical connection assembly out of the housing, the present application reduces the overall volume of the device 10, thereby obtaining a more compact structure applicable in a miniaturized equipment. The direct connection between the drive portion 412 and the electrical connection assembly 500 enables a faster adjustment speed and highly responsive operation. Simultaneously, the circuit board 300 accurately senses positional changes, which provides superior control accuracy, reduces adjustment time, and improves overall efficiency.

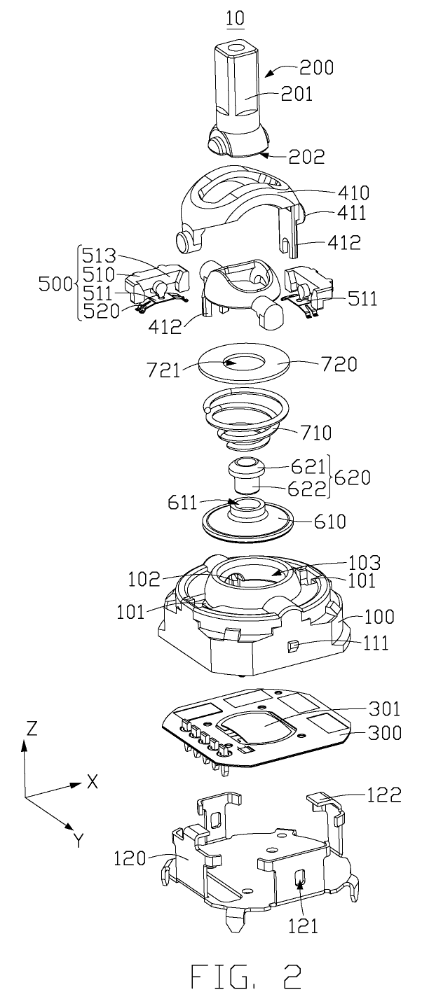

Referring to FIG. 2, in this embodiment, the housing 100 includes a first mounting opening 101 and a second mounting opening 102. The first mounting opening 101 is arranged along the third direction Z. The second mounting opening 102 is arranged along a second direction Y. The third direction Z and the second direction Y are perpendicular to each other. The first swinging arm 401 is rotatably mounted at the first mounting opening 101. The second swinging arm 402 is rotatably mounted at the second mounting opening 102. The drive portion 412 extends through the first mounting opening 101 or the second mounting opening 102 into the housing 100. The drive portion 412 is drivingly coupled to the electrical connection assembly 500.

In some embodiments, the electrical connection assembly 500 includes two driven interfaces, each of the two driven interfaces being, for example, a follower slot, a coupling lug, or a linkage seat. One driven interface is coupled to the drive portion 412 of the first swinging arm 401. Another driven interface is coupled to the drive portion 412 of the second swinging arm 402.

In some embodiments, the first mounting opening 101 faces the same direction as the opening 103. The second mounting opening 102 faces an opposite direction of the opening 103. Thereby, the first swinging arm 401 and the second swinging arm 402 are perpendicular to each other, which reduces the overall size of the device 10, and improves portability. Furthermore, the drive portion 412 is connected to the electrical connection assembly 500, so that signals generated in response to the swinging of the operation member 20 are transmitted quickly and accurately.

Referring to FIG. 2, in this embodiment, the first mounting opening 101 faces outward from the cavity 104. At least a portion of the first swinging arm 401 is arranged outside the cavity 104. The second mounting opening 102 faces inward toward the cavity 104. At least a portion of the second swinging arm 402 is arranged inside the cavity 104. Thus, the utilization of the internal space of the device 10 is improved. Also, the overall volume of the device 10 decreases, so that the installation of the device 10 is simple and the operational stability of the device 10 is improved.

Referring to FIGS. 1 to 3, in this embodiment, the housing 100 includes a base 110 and a fixing member 120. The fixing member 120 is sleeved over an outer side of the base 110. The base 110 includes a latch protrusion 111, and the fixing member 120 includes a latch opening 121. At least a portion of the latch protrusion 111 is received in the latch opening 121. This configuration ensures a tighter connection between the fixing member 120 and the base 110, which reduces the risk of loosening the fixing member 120 relative to the base 110 and also facilitates the assembly and maintenance of the device 10. Furthermore, the fixing member 120 fixes the circuit board 300 relative to the base 110. The fixing member 120 further includes a fixing portion 122, which is arranged to retain the first swinging arm 401 in the first mounting opening 101. The fixing portion 122 retains the first swinging arm 401 in the first mounting opening 101 in a direction along the central axis A of the operation member 20. The design of the fixing portion 122 secures the first swinging arm 401 more firmly, thereby enhancing the control accuracy and response speed of the device 10.

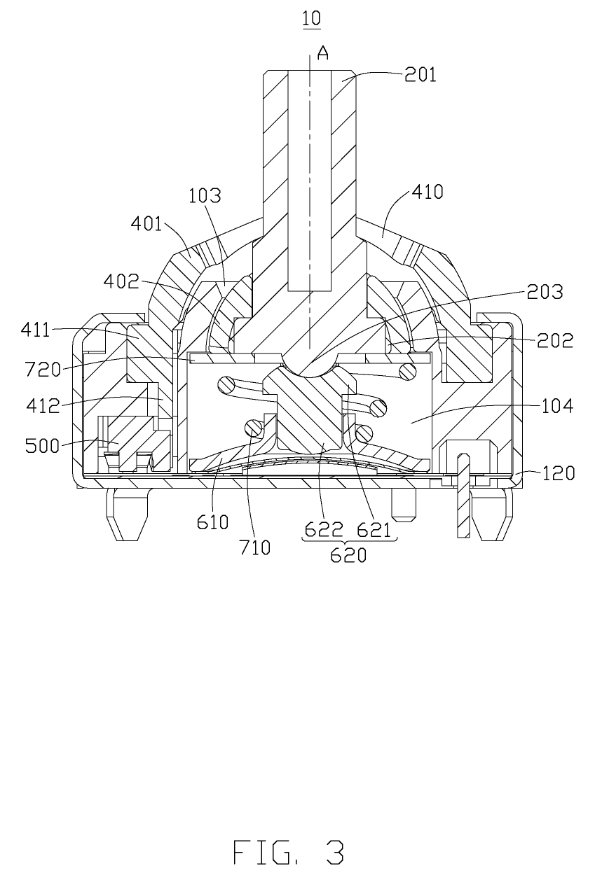

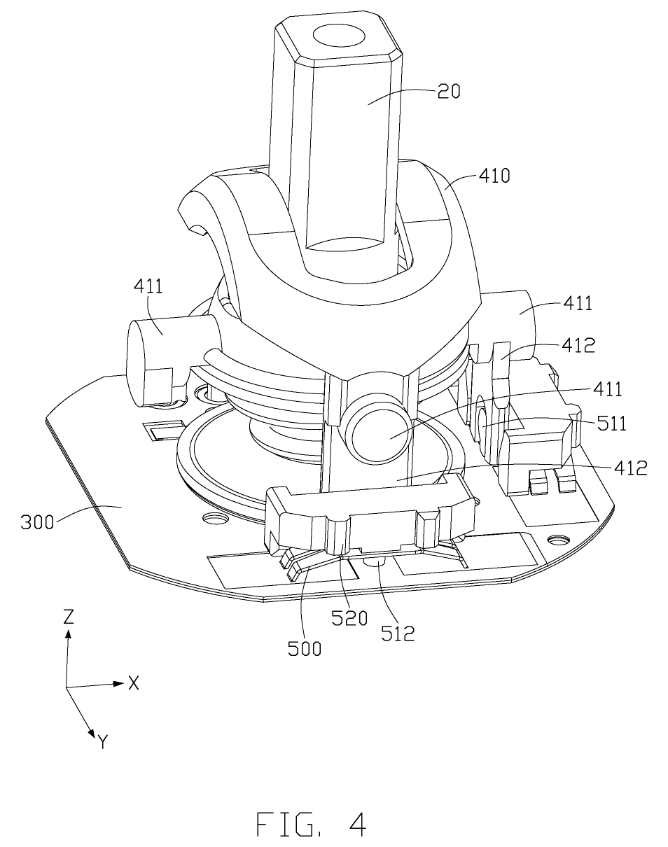

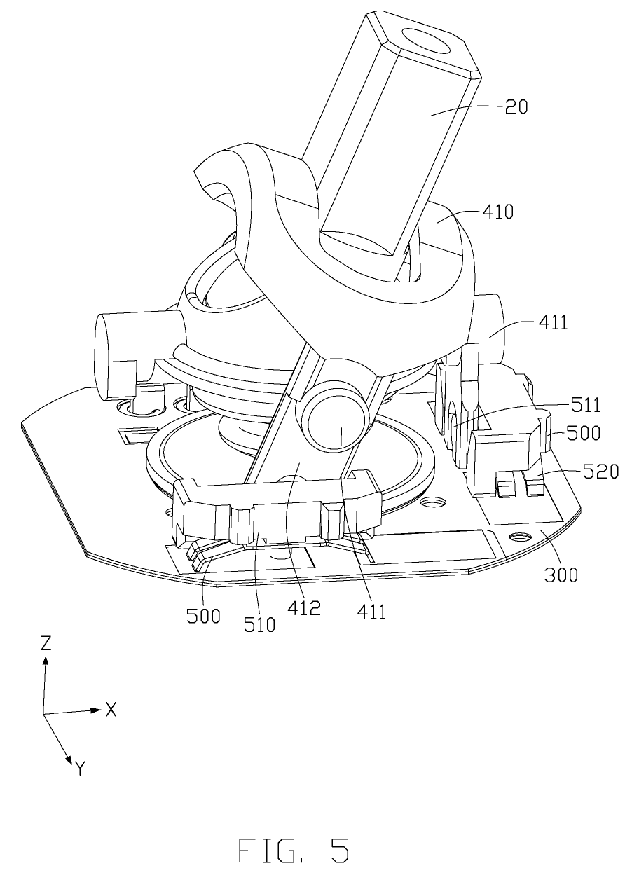

Referring to FIGS. 3, 4 and 5, in this embodiment, the electrical connection assembly 500 includes a slider 510 and a sliding terminal 520. The sliding terminal 520 is mounted on the slider 510. The sliding terminal 520 is in electrical contact with the circuit board 300. The drive portion 412 is connected to the slider 510. When the swinging body 410 drives the drive portion 412 to move, the drive portion 412 moves the slider 510. Thus, the sliding terminal 520 slides along the circuit board 300. This arrangement of the slider 510 and the sliding terminal 520 ensures efficient transmission of electrical signals. Specifically, when the swinging body 410 moves the drive portion 412, the sliding terminal 520 is driven by the slider 510 to slide over the circuit board 300. This mechanism further optimizes the motion transmission within the device. The movement of the slider 510, which follows the swinging of the operation member 20, can achieve accurate sensing of positional changes by the circuit board 300. Moreover, the electrical connection design between the sliding terminal 520 and the circuit board 300 reduces signal interference and loss during transmission, thereby enhancing the control accuracy of the input device 10.

Referring to FIGS. 2, 3, 4 and 5, in this embodiment, the slider 510 includes a first connection portion 511 and a second connection portion 512. The slider 510 defines a slot 513. The first connection portion 511 is arranged in the slot 513. The drive portion 412 is inserted into the slot 513. The drive portion 412 is connected to the first connection portion 511. The second connection portion 512 is arranged at an end of the slider 510 opposite to the drive portion 412. The sliding terminal 520 is mounted to the second connection portion 512, ensuring a stable electrical connection between the circuit board 300 and the slider 510. This configuration allows the sliding terminal 520 to maintain an optimal electrical connection state while moving with the slider 510, thereby avoiding signal distortion caused by such movement. Furthermore, since the slider 510 includes the first connection portion 511 and the second connection portion 512, the assembly and maintenance of the device 10 is facilitated.

Referring to FIG. 3, in this embodiment, the device 10 further includes a pressing assembly 600. The pressing assembly 600 includes a stop member 610, a pressing member 620, and a resetting assembly 700. The stop member 610 is arranged in the cavity 104. The stop member 610 defines a limit opening 611. The limit opening 611 is coaxial with the opening 103. The pressing member 620 includes a second end 621 and a third end 622. The second end 621 extends through the limit opening 611 into the stop member 610. A movable contact 301 is arranged on the circuit board 300. The second end 621 is configured to abut against the movable contact 301. The third end 622 abuts against the operation member 20. When the operation member 20 is pressed, the pressing member 620 actuates the movable contact 301 through the second end 621. The resetting assembly 700 is arranged in the cavity 104. The operation body 200 further includes a fourth end 202 opposite to the first end 201. The resetting assembly 700 elastically abuts against the fourth end 202. When at least a portion of the operation member 20 swings in the cavity 104, the resetting assembly 700 can return the operation member 20 toward a neutral position.

Referring to FIGS. 2 and 3, in this embodiment, the resetting assembly 700 includes an elastic member 710 and a pressing plate 720. The elastic member 710 is arranged at a side of the stop member 610 facing the opening 103. The pressing plate 720 is arranged at a side of the elastic member 710 near the opening 103. The elastic member 710 presses the pressing plate 720 against a lower side of the fourth end 202. The fourth end 202 abuts against a surface of the pressing plate 720 facing the limit opening 611. The pressing plate 720 defines a through hole 721. The operation body 200 includes a pressing portion 203. The pressing portion 203 passes through the through hole 721. The pressing portion 203 abuts the third end 622 of the pressing member 620. This configuration ensures that the operation member 20 can quickly return to the neutral position after the operation member 20 is swung or pressed, thereby reducing the displacement or deviation caused by the external force. Furthermore, the elastic design of the elastic member 710 enables the resetting assembly 700 to quickly return the operation member 20 to the neutral position, thereby reducing delay and operational error. The through hole 721 in the pressing plate 720 allows the pressing portion 203 to pass through the pressing plate 720 smoothly, ensuring efficient transmission of the pressing function.

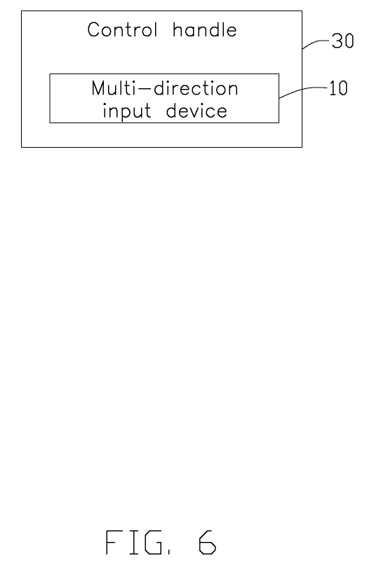

Referring to FIG. 6, a control handle 30 is provided according to an embodiment of the present application. The control handle 30 includes the device 10. The compact structure of the device 10 allows the device 10 to be applied in a portable device. Furthermore, the high sensitivity of the device 10 realizes the precise control of the control handle 30.

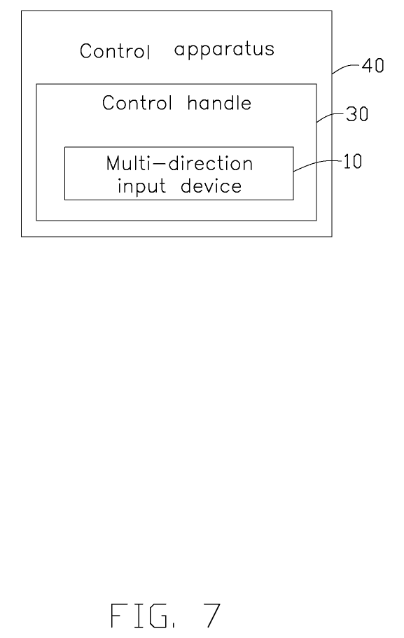

Referring to FIG. 7, a control apparatus 40 is provided according to an embodiment of the present application. The control apparatus 40 includes the control handle 30. The control apparatus 40 may be a compact camera. The control apparatus 40 may also be a stabilizer.

The embodiments described above are examples. Many details are well known in the art and are omitted for conciseness. Even though numerous characteristics and advantages of the present technology have been set forth above, the description is illustrative only, and changes may be made in detail, including the shape, size, and arrangement of parts, within the scope of the present disclosure and the appended claims. Accordingly, the embodiments may be modified within the scope of the claims.

What is claimed is:

1. A multi-direction input device, comprising:
a housing defining a cavity and an opening communicating with the cavity;
an operation member partially disposed in the cavity;
a swinging assembly partially disposed in the housing;
a circuit board disposed in the cavity; and
an electrical connection assembly connected to the circuit board;
wherein the operation member is swingable relative to the housing, the operation member comprises an operation body comprising a first end protruding from the cavity through the opening;
the swinging assembly is rotatably connected to the housing, the swinging assembly is connected to the operation member, the swinging assembly comprises a first swinging arm and a second swinging arm, the first swinging arm is rotatable around a first direction, and the second swinging arm is rotatable around a second direction perpendicular to the first direction;
at least one of the first swinging arm and the second swinging arm comprises a swinging body, two pivot portions, and a drive portion, the two pivot portions are arranged at opposite ends of the swinging body, respectively, the drive portion is arranged on one of the two pivot portions and disposed in the cavity; the electrical connection assembly is connected to the drive portion, and the circuit board is configured to sense a positional change of the electrical connection assembly.

2. The multi-direction input device of claim 1, wherein the housing comprises a first mounting opening and a second mounting opening, the first swinging arm is rotatably mounted to the first mounting opening, the second swinging arm is rotatably mounted to the second mounting opening, and the drive portion extends through the first mounting opening or the second mounting opening into the housing to couple to the electrical connection assembly.

3. The multi-direction input device of claim 2, wherein the first mounting opening faces outward of the cavity, at least a portion of the first swinging arm is disposed outside of the cavity, the second mounting opening faces inward of the cavity, and at least a portion of the second swinging arm is disposed inside of the cavity.

4. The multi-direction input device of claim 3, wherein the housing comprises a base and a fixing member sleeved on the base, the base comprises a latch protrusion, the fixing member defines a latch opening configured for receiving at least a portion of the latch protrusion, the fixing member fixes the circuit board to the base, the fixing member comprises a fixing portion, the fixing portion is configured to fix the first swinging arm to the first mounting opening along an axis of the operation member.

5. The multi-direction input device of claim 1, wherein the electrical connection assembly comprises a slider and a sliding terminal disposed on the slider, the sliding terminal is electrically connected to the circuit board, the drive portion is connected to the slider, and the slider is configured to move the sliding terminal on the circuit board in response to the swinging body moves the drive portion.

6. The multi-direction input device of claim 5, wherein the slider defines a slot, the slider comprises a first connection portion and a second connection portion, the first connection portion is disposed in the slot, the drive portion is inserted into the slot and connected to the first connection portion, the second connection portion is at an end of the slider opposite to the drive portion, and the sliding terminal is mounted to the second connection portion.

7. The multi-direction input device of claim 1, further comprising a pressing assembly, wherein the pressing assembly comprises a stop member, a pressing member, and a resetting assembly, the stop member is disposed in the cavity, the stop member defines a limit opening coaxial with the opening, the pressing member comprises a second end and a third end, the second end extends through the limit opening into the stop member, the circuit board comprises a movable contact, the second end is configured to abut against the movable contact, the third end is configured to abut against the operation member, and the resetting assembly is disposed in the cavity, the operation body further comprises a fourth end opposite to the first end, and the resetting assembly is configured to elastically abut against the fourth end of the operation body,
when the operation member is pressed, the pressing member is configured to actuate the movable contact via the second end; and
in a case that the operation member is swung in the cavity, the resetting assembly is configured to return the operation member toward a neutral position.

8. The multi-direction input device of claim 7, wherein the resetting assembly comprises an elastic member and a pressing plate, the elastic member is disposed on a side of the stop member facing the opening, the pressing plate is adjacent to the elastic member and biased thereby against a side of the fourth end of the operation body, the side of the fourth end of the operation body faces the limit opening, the pressing plate defines a through hole, the operation body comprises a pressing portion, and the pressing portion extends through the through hole to abut against the third end of the pressing member.

9. A control handle, comprising the multi-direction input device, wherein the multi-direction input device comprises:
a housing defines a cavity and an opening communicating with the cavity;
an operation member partially disposed in the cavity;
a swinging assembly partially disposed in the housing;
a circuit board disposed in the cavity; and
an electrical connection assembly connected to the circuit board;
wherein the operation member is swingable relative to the housing, the operation member comprises an operation body, the operation body comprises a first end protruding from the cavity through the opening;
the swinging assembly is rotatably connected to the housing, the swinging assembly is connected to the operation member, the swinging assembly comprises a first swinging arm and a second swinging arm, the first swinging arm is rotatable around a first direction, and the second swinging arm is rotatable about a second direction perpendicular to the first direction;
at least one of the first swinging arm and the second swinging arm comprises a swinging body, two pivot portions, and a drive portion, the two pivot portions are arranged at opposite ends of the swinging body, the drive portion is arranged on one of the two pivot portions, the drive portion is disposed in the cavity; the electrical connection assembly is connected to the drive portion, and the circuit board is configured to sense a positional change of the electrical connection assembly.

10. The control handle of claim 9, wherein the housing comprises a first mounting opening and a second mounting opening, the first swinging arm is rotatably mounted to the first mounting opening, the second swinging arm is rotatably mounted to the second mounting opening, and the drive portion extends through the first mounting opening or the second mounting opening into the housing to couple to the electrical connection assembly.

11. The control handle of claim 10, wherein the first mounting opening faces outward of the cavity, at least a portion of the first swinging arm is disposed outside the cavity, the second mounting opening faces inward of the cavity, and at least a portion of the second swinging arm is disposed inside the cavity.

12. The control handle of claim 11, wherein the housing comprises a base and a fixing member sleeved on the base, the base comprises a latch protrusion, the fixing member defines a latch opening configured for receiving at least a portion of the latch protrusion, the fixing member fixes the circuit board to the base, the fixing member comprises a fixing portion, the fixing portion is configured to fix the first swinging arm to the first mounting opening along an axis of the operation member.

13. The control handle of claim 9, wherein the electrical connection assembly comprises a slider and a sliding terminal disposed on the slider, the sliding terminal is electrically connected to the circuit board, the drive portion is connected to the slider, and the slider is configured to move the sliding terminal on the circuit board in response to the swinging body moves the drive portion.

14. The control handle of claim 13, wherein the slider defines a slot, the slider comprises a first connection portion and a second connection portion, the first connection portion is disposed in the slot, the drive portion is inserted into the slot and connected to the first connection portion, the second connection portion is at an end of the slider opposite to the drive portion, and the sliding terminal is mounted to the second connection portion.

15. The control handle of claim 9, the multi-direction input device further comprises a pressing assembly, wherein the pressing assembly comprises a stop member, a pressing member, and a resetting assembly, the stop member is disposed in the cavity, the stop member defines a limit opening coaxial with the opening, the pressing member comprises a second end and a third end, the second end extends through the limit opening into the stop member, the circuit board comprises a movable contact, the second end is configured to abut against the movable contact, the third end is configured to abut against the operation member, and the resetting assembly is disposed in the cavity, the operation body further comprises a fourth end opposite to the first end, and the resetting assembly is configured to elastically abut against the fourth end of the operation body,
when the operation member is pressed, the pressing member is configured to actuate the movable contact via the second end; and
in a case that the operation member is swung in the cavity, the resetting assembly is configured to return the operation member toward a neutral position.

16. The control handle of claim 15, wherein the resetting assembly comprises an elastic member and a pressing plate, the elastic member is disposed on a side of the stop member facing the opening, the pressing plate is adjacent to the elastic member and biased thereby against a side of the fourth end of the operation body, the side of the fourth end of the operation body faces the limit opening, the pressing plate defines a through hole, the operation body comprises a pressing portion, and the pressing portion extends through the through hole to abut against the third end of the pressing member.

17. A control apparatus, comprising the control handle, wherein the control handle comprises a multi-direction input device, the multi-direction input device comprises:
a housing defines a cavity and an opening communicating with the cavity;
an operation member partially disposed in the cavity;
a swinging assembly partially disposed in the housing;
a circuit board disposed in the cavity; and
an electrical connection assembly connected to the circuit board;
wherein the operation member is swingable relative to the housing, the operation member comprises an operation body, the operation body comprises a first end protruding from the cavity through the opening;
the swinging assembly is rotatably connected to the housing, the swinging assembly is connected to the operation member, the swinging assembly comprises a first swinging arm and a second swinging arm, the first swinging arm is rotatable around a first direction, and the second swinging arm is rotatable about a second direction perpendicular to the first direction;
at least one of the first swinging arm and the second swinging arm comprises a swinging body, two pivot portions, and a drive portion, the two pivot portions are arranged at opposite ends of the swinging body, the drive portion is arranged on one of the two pivot portions, the drive portion is disposed in the cavity; the electrical connection assembly is connected to the drive portion, and the circuit board is configured to sense a positional change of the electrical connection assembly.

18. The control apparatus of claim 17, wherein the housing comprises a first mounting opening and a second mounting opening, the first swinging arm is rotatably mounted to the first mounting opening, the second swinging arm is rotatably mounted to the second mounting opening, and the drive portion extends through the first mounting opening or the second mounting opening into the housing to couple to the electrical connection assembly.

19. The control apparatus of claim 18, wherein the first mounting opening faces outward of the cavity, at least a portion of the first swinging arm is disposed outside the cavity, the second mounting opening faces inward of the cavity, and at least a portion of the second swinging arm is disposed inside the cavity.

20. The control apparatus of claim 19, wherein the housing comprises a base and a fixing member sleeved on the base, the base comprises a latch protrusion, the fixing member defines a latch opening for receiving at least a portion of the latch protrusion, the fixing member fixes the circuit board to the base, the fixing member comprises a fixing portion, the fixing portion is configured to fix the first swinging arm to the first mounting opening along an axis of the operation member.
